(19) United States
(12) Patent Application Publication
(10) Pub. No.: US 2009/0169288 A1
(43) Pub. Date: Jul. 2, 2009

(54) FILE

(75) Inventors: Kanji Tanaka, Osaka (JP); Hiroshi Arai, Osaka (JP); Mitsunori Maeda, Osaka (JP)

Correspondence Address: OKADA;C/O KEATING & BENNETT, LLP, 1800 Alexander Bell Drive, SUITE 200, Reston, VA, 20191, US

(73) Assignee: LIHIT LAB., INC., Osaka-shi, Osaka (JP)

(21) Appl. No.: 12/089,081

(22) PCT Filed: Dec. 28, 2005
(86) PCT No.: PCT/JP2005/024085

§ 371 Date: Apr. 3, 2008

(30) Foreign Application Priority Data
Oct. 4, 2005 (JP) 2005-291223

(51) Int. Cl. B42F 13/00; B42D 1/00; B42D 3/00

(52) U.S. Cl. 402/75; 281/21.1; 281/29

(57) ABSTRACT

A binding device of a file is attached to a cover configured to be bendable at the central portion in the width direction of a spine. The binding device includes a synthetic resin first main body and a synthetic resin second main body which are arranged to be openable and closable. A synthetic resin locking member having two hook portions is integrally provided with the first main body, and a metal first prong member is mounted to the first main body. A metal second prong member is mounted to the second main body. Furthermore, a synthetic resin lever member is slidably provided in the second main body.

### BACKGROUND OF THE INVENTION

1. Field of the Invention

The present invention relates to files. In particular, the present invention relates to files and binders including a binding device that is to be attached to a cover having a spine that is bendable at a widthwise central portion, the binding device having a plurality of arc-shaped prongs and being used for files and binders in which objects to be bound, such as paper sheets, are bound by extending the prongs through binding holes provided in the objects to be bound.

2. Description of the Related Art

A conventional binding device for binders includes a pair of synthetic resin back sections connected to each other through a hinge in an openable-closable manner, each of the back sections arranged to be attached to a cover of a binder, a pair of metal plates riveted to the pair of back sections, a plurality of metal arc-shaped prongs mounted to each of the pair of metal plates, a metal locking member riveted to one of the back sections and having two hook portions, a metal latch member slidably provided in the other back section, the latch member having a notch for inserting the locking member and being capable of engaging with one of the two hook portions of the locking member, a metal hairpin spring for urging the latch member in one direction so that one of the two hook portions of the locking member is engaged with the latch member, and a synthetic resin key that causes the latch member to slide in a direction opposite to the one direction against the urging force of the hairpin spring so that when the key is pressed, the hook portion of the locking member is disengaged from the latch portion.

Furthermore, in such a conventional binding device for binders, the pair of back sections or the plurality of prongs can be held in one of the following three states according to whether the latch member is engaged with one of the two hook portions of the locking member or is not engaged with any of the two hook portions: a fully closed state; a fully opened state; and an intermediate state between the fully closed state and the fully opened state (see, for example, U.S. Pat. No. 4,352,582).

With a binder including the conventional binding device, bound paper sheets are loosened when the pair of back sections or the plurality of prongs defining the binding device are held in the intermediate state between the fully closed state and the fully opened state, and therefore, the bound paper sheets can be easily turned over. Accordingly, information on the front and back surfaces of the bound paper sheets can be easily read.

The above-described conventional binding device for binders includes a large number of components, including the pair of synthetic resin back sections, the pair of riveted metal plates, the plurality of metal prongs, the metal riveted locking member, the metal latch member, the metal hairpin spring, and the synthetic resin key. Thus, the assembly of the binding device is complicated, and therefore, the manufacturing costs are high.

As described above, the conventional binding device for binders includes a large number of components, which increases the overall weight of files and binders. As the number of bound objects increases, the overall weight further increases.

In order to facilitate handling of files and binders, it is desirable for such files and binders to have a reduced overall weight while maintaining their rigidity.

### SUMMARY OF THE INVENTION

To overcome the problems described above, preferred embodiments of the present invention provide files and binders that can be easily assembled and have a reduced weight while maintaining their rigidity.

A file according to a preferred embodiment of the present invention includes a cover and a binding device secured to the cover. The cover includes a thin spine, a thin front cover provided on a first widthwise end side of the spine through a first fixing portion, and a thin back cover provided on a second widthwise end side of the spine through a second fixing portion, the front cover and the spine being fixed to each other by the first fixing portion so as to define a predetermined angle, the back cover and the spine being fixed to each other by the second fixing portion so as to define a predetermined angle, the spine being configured so as to be bendable at a widthwise intermediate portion thereof, the front cover being configured so as to be bendable at a portion in proximity to the spine, the back cover being configured so as to be bendable at a portion in proximity to the spine. The binding device includes a first main body which is disposed on an inner side of the spine so as to be located on a front cover side, a second main body which is disposed on the inner side of the spine so as to be located on a back cover side, the first main body of the binding device including an elongated substantially rectangular plate-shaped first base portion, and a first side-portion integrally provided with the first base portion, the first base portion having a width substantially the same as a width of the first spine portion and having a length less than a longitudinal length of the first spine portion in order to face a first spine portion, the first side-portion facing a portion of the front cover, the portion being in proximity to the spine, the first side-portion having a plate shape so as to be adjusted to the angle between by the spine and the front cover, the second main body of the binding device including an elongated substantially rectangular plate-shaped second base portion, and a second side-portion integrally provided with the second base portion, the second base portion having a width substantially the same as a width of the second spine portion and having a length less than a longitudinal length of the second spine portion in order to face a second spine portion, the second side-portion facing a portion of the back cover, the portion being in proximity to the spine, the second side-portion having a plate shape so as to be adjusted to the angle between by the spine and the back cover, the first main body and the second main body of the binding device being secured to the first spine portion and the second spine portion, respectively, on opposite sides of a bendable portion of the spine of the cover.

Preferably, the spine includes a thin-walled bendable portion provided in a widthwise central portion thereof and extending linearly from an upper end of the cover to a lower end of the cover, the front cover includes a thin-walled first bendable portion provided in proximity to the spine and extending linearly from the upper end of the cover to the lower end of the cover, a portion between the first bendable portion and a boundary between the front cover and the spine being provided as a first fixed portion, and the back cover includes a thin-walled second bendable portion provided in proximity to the spine and extending linearly from the upper end of the cover to the lower end of the cover, a portion between the second bendable portion and a boundary between the back cover and the spine being provided as a second fixed portion.

Preferably, the first base portion of the first main body is fastened to an inner surface of the first spine portion with a fastener, and the second base portion of the second main body is fastened to an inner surface of the second spine portion with a fastener.

Preferably, the first side-portion of the first main body is in close contact with the first fixed portion of the front cover, and the second side-portion of the second main body is in close contact with the second fixed portion of the back cover.

Preferably, the binding device includes the first main body which is secured on the inner side of the spine so as to be located on a first side of a widthwise central portion of the spine and includes a locking member having a hook portion, the locking member being integrally provided with the first main body, the second main body which is secured on the inner side of the spine so as to be located on a second side of the widthwise central portion of the spine and is arranged to be openable and closable together with the first main body, a first prong member mounted to the first main body and having a plurality of prongs provided therein, and a second prong member mounted to the second main body and having a plurality of prongs provided therein.

According to preferred embodiments of the present invention, the first main body of the binding device includes the elongated plate-shaped first base portion. In order to face the first spine portion, the first base portion has a width substantially the same as the width of the first spine portion and a length less than the longitudinal length of the first spine portion. The first base portion is integrally provided with the plate-shaped first side-portion such that the first side-portion faces a portion of the front cover, the portion being in proximity to the spine. The second main body of the binding device includes the elongated plate-shaped base portion. In order to face the second spine portion, the second base portion has a width substantially the same as the width of the second spine portion and a length less than the longitudinal length of the second spine portion. The second base portion is integrally provided with the plate-shaped second side-portion such that the second side-portion faces a portion of the back cover, the portion being in proximity to the spine. In addition, since the first main body and the second main boy of the binding device are secured to the first spine portion and the second spine portion, respectively, on the opposite sides of the bendable portion of the spine of the cover, the cover is reinforced by the first and second main bodies of the binding device. Accordingly, files and binders can be obtained which can be easily assembled and have a reduced thickness to reduce the weight while maintaining their rigidity.

The spine preferably includes the thin bendable portion provided in a central portion in the width direction and extending linearly from the upper end of the cover to the lower end of the cover. The front cover includes the thin first bendable portion provided in proximity to the spine and extending linearly from the upper end of the cover to the lower end of the cover, and a portion between the first bendable portion and the boundary between the front cover and the spine is provided as the first fixed portion. The back cover includes the thin second bendable portion provided in proximity to the spine and extending linearly from the upper end of the cover to the lower end of the cover, and a portion between the second bendable portion and the boundary between the back cover and the spine is provided as the second fixed portion. Therefore, since the first side-portion of the first main body extends along the first fixed portion, the shape formed by the first fixed portion and the first spine portion can be maintained for a long period of time. In addition, since the second side-portion of the second main body extends along the second fixed portion, the shape formed by the second fixed portion and the second spine portion can be maintained for a long period of time. When the cover is opened and closed, the side portion thereof outside the first bendable portion is opened and closed. Therefore, the shape formed by the first fixed portion and the first spine portion and the shape formed by the second fixed portion and the second spine portion are not affected by the opening and closing operation. Accordingly, the predetermined shape of the cover can be maintained for a long period of time.

The first base portion of the first main body is preferably fastened to the inner side of the first spine portion with a fastener, and the second base portion of the second main body is fastened to the inner side of the second spine portion with a fastener. Therefore, the first spine portion is reinforced by the first main body, and the second spine portion is reinforced by the second main body. Accordingly, even when the cover is made of a relatively thin material to reduce the weight in order to facilitate handling, a rigid file can be obtained.

The first side-portion of the first main body is preferably in close contact with the first fixed portion of the front cover, and the second side-portion of the second main body is preferably in close contact with the second fixed portion of the back cover. Since the first side-portion of the first main body extends along the first fixed portion, the shape formed by the first fixed portion and the first spine portion can be maintained for a long period of time. In addition, since the second side-portion of the second main body extends along the second fixed portion, the shape formed by the second fixed portion and the second spine portion can be maintained for a long period of time. When the cover is opened and closed, the side portion thereof outside the first bendable portion is opened and closed. Therefore, the shape formed by the first fixed portion and the first spine portion and the shape formed by the second fixed portion and the second spine portion are not affected by the opening and closing operation. Accordingly, the predetermined shape of the cover can be maintained for a long period of time.

The above and other elements, features, steps and advantages of the present invention will become more readily apparent from the following description of preferred embodiments of the present invention with reference to the accompanying drawings.

In the description of preferred embodiments of the present invention, including the claims, the term “file” or “files and binders” is used as a generic term for files and binders such as files (covers which can bind almost finished documents such as slips, brochures, and papers or can hold such documents for filing and archiving purposes) and binders (covers which are provided with a binding device and are capable of holding, in a writable manner, almost unwritten paper sheets, such as loose leaves and accounting forms, having binding holes and inserted therein).

### BRIEF DESCRIPTION OF THE DRAWINGS

FIG. 1 is a perspective view illustrating a file including a binder device according to preferred embodiments of the present invention.

FIG. 2 is a plan view of the file shown in FIG. 1.

FIG. 3 is a plan view illustrating a fully closed state of a binding device of the file shown in FIG. 1.

FIG. 4 is a front view illustrating the fully closed state of the binding device of the file shown in FIG. 1.

FIG. 5 is a plan view illustrating an intermediate state of the binding device of the file shown in FIG. 1, the intermediate state being between the fully closed state and a fully opened state.

FIG. 6 is a front view illustrating the intermediate state of the binding device of the file shown in FIG. 1.

FIG. 7 is a plan view illustrating the fully opened state of the binding device of the file shown in FIG. 1.

FIG. 8 is a front view illustrating the fully opened state of the binding device of the file shown in FIG. 1.

FIG. 9 is a perspective view of the binding device used in the file shown in FIG. 1.

FIG. 10 is an exploded perspective view of the binding device shown in FIG. 9.

FIG. 11 is a bottom view of a first main body used in the binding device shown in FIG. 9.

FIG. 12 is a left side view of the first main body used in the binding device shown in FIG. 9.

FIG. 13 is a perspective view illustrating a second main body and a lever member used in the binding device shown in FIG. 9.

FIG. 14 is a bottom view of the second main body used in the binding device shown in FIG. 9.

FIG. 15 is a plan view illustrating another file including a binder device according to preferred embodiments of the present invention.

### DETAILED DESCRIPTION OF PREFERRED EMBODIMENTS

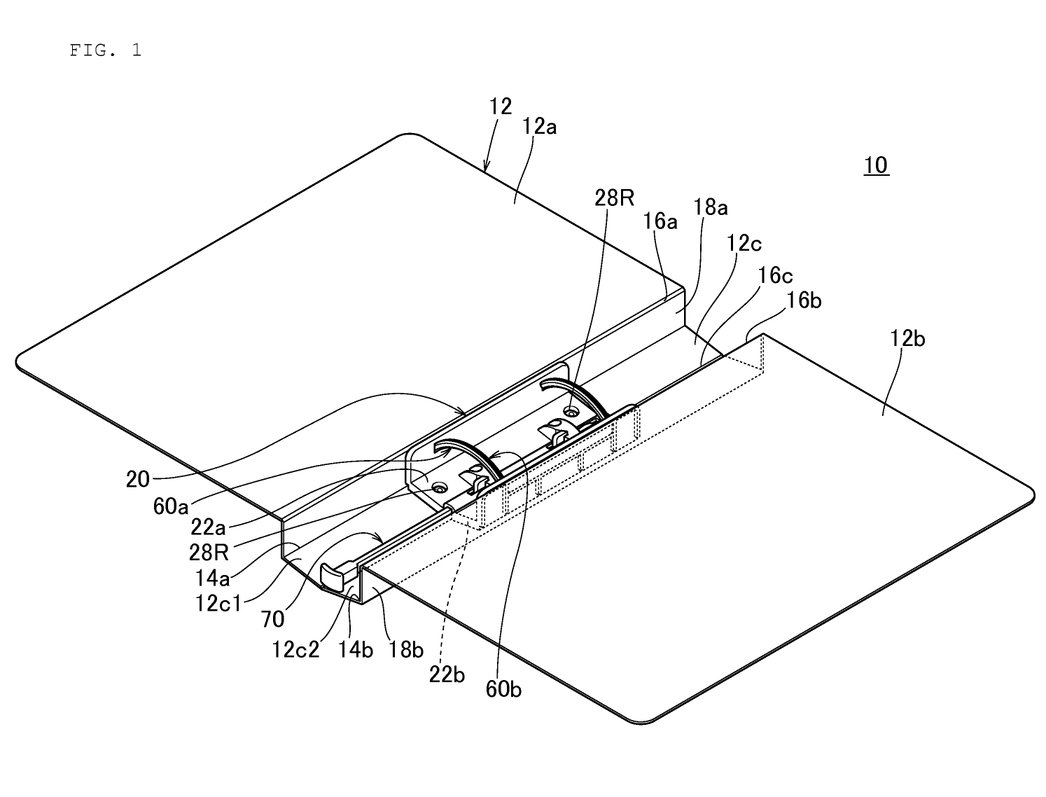

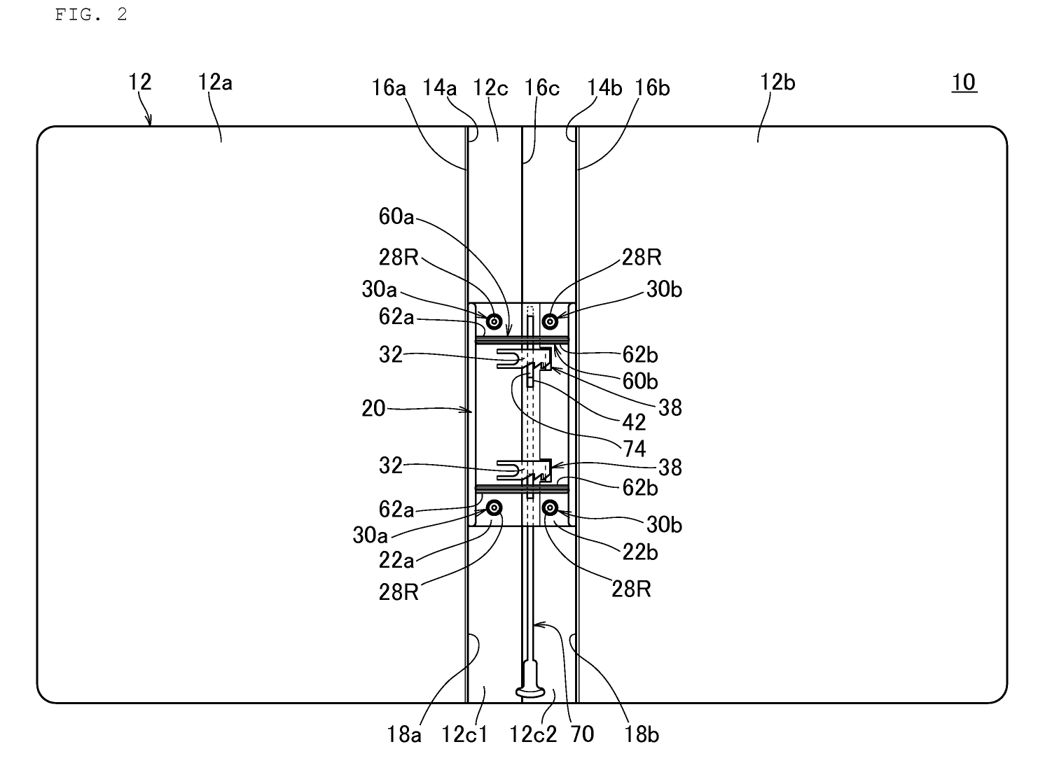

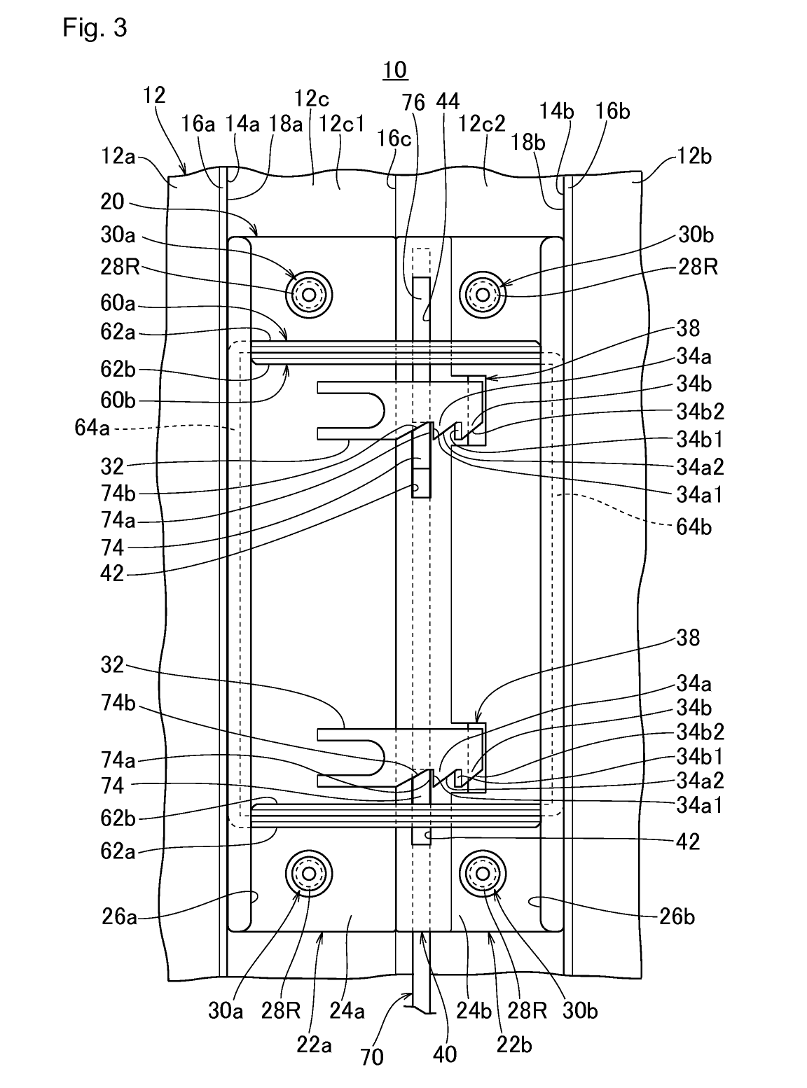

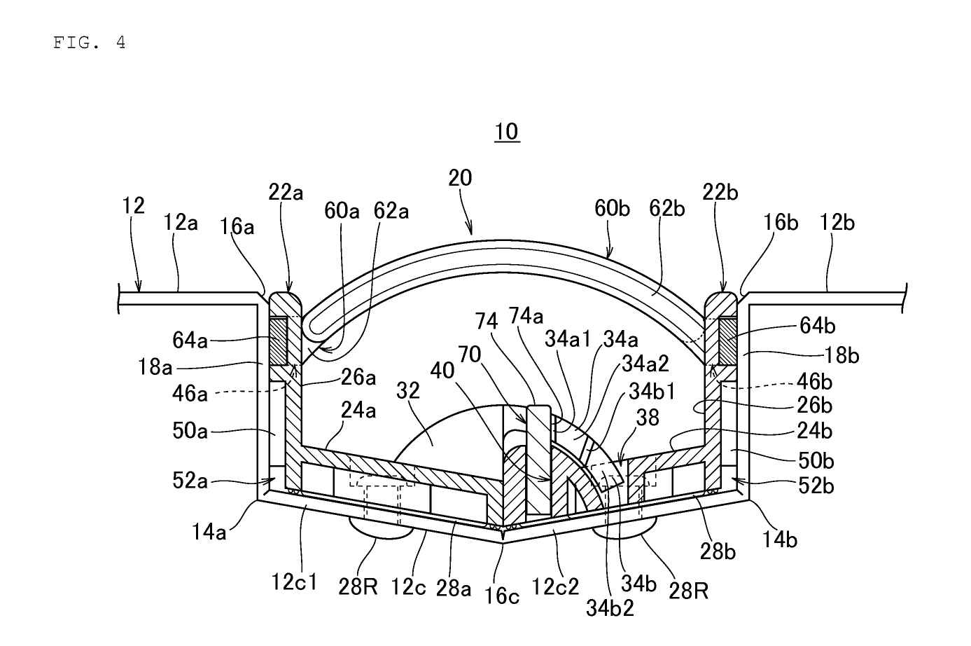

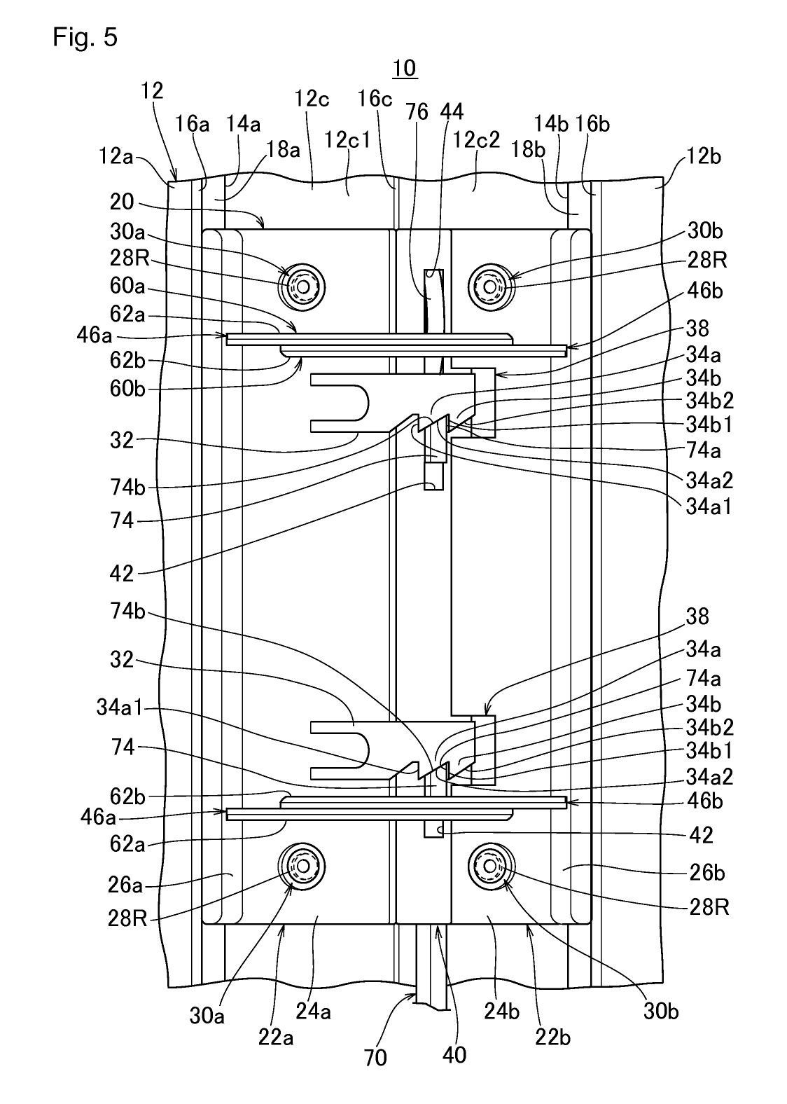

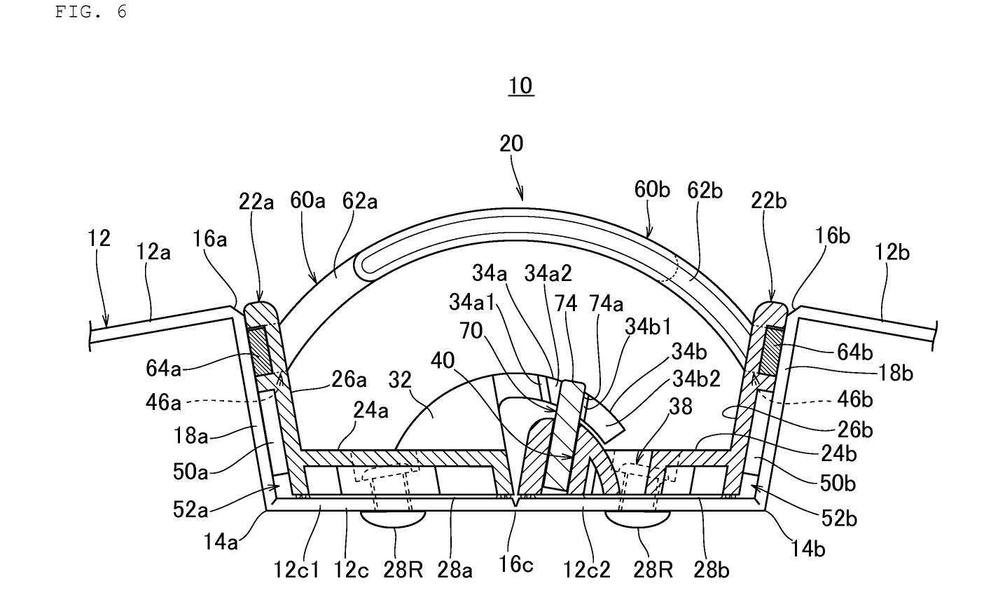

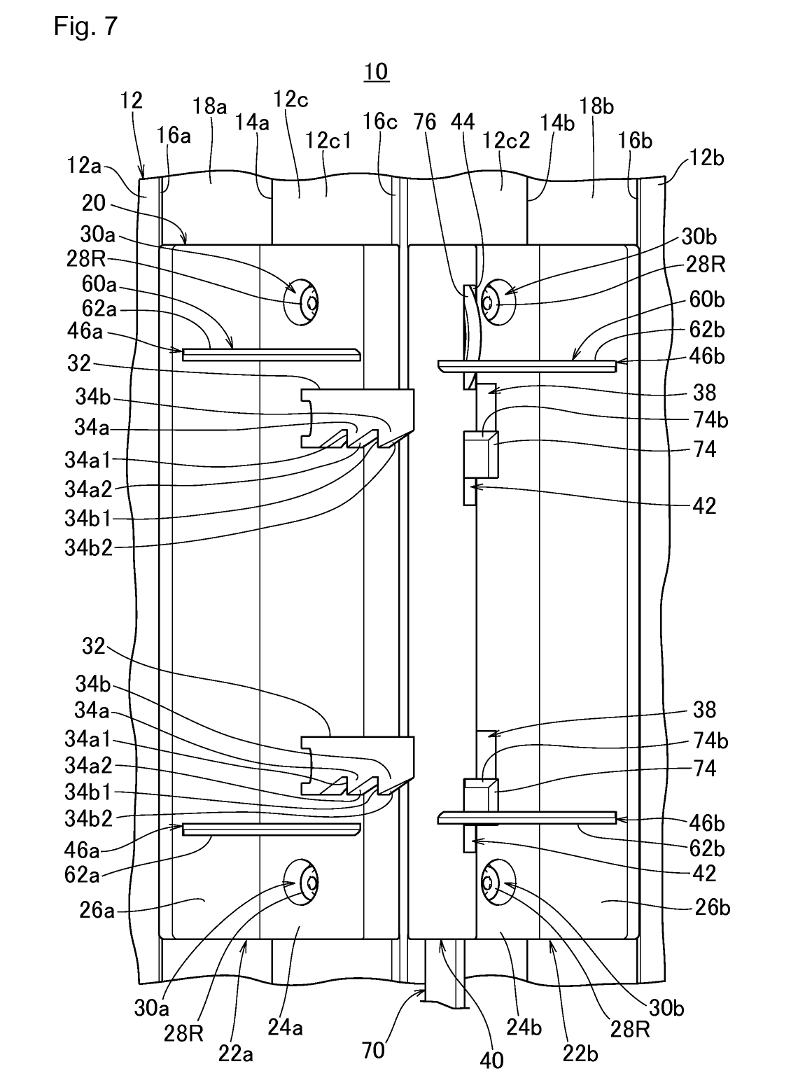

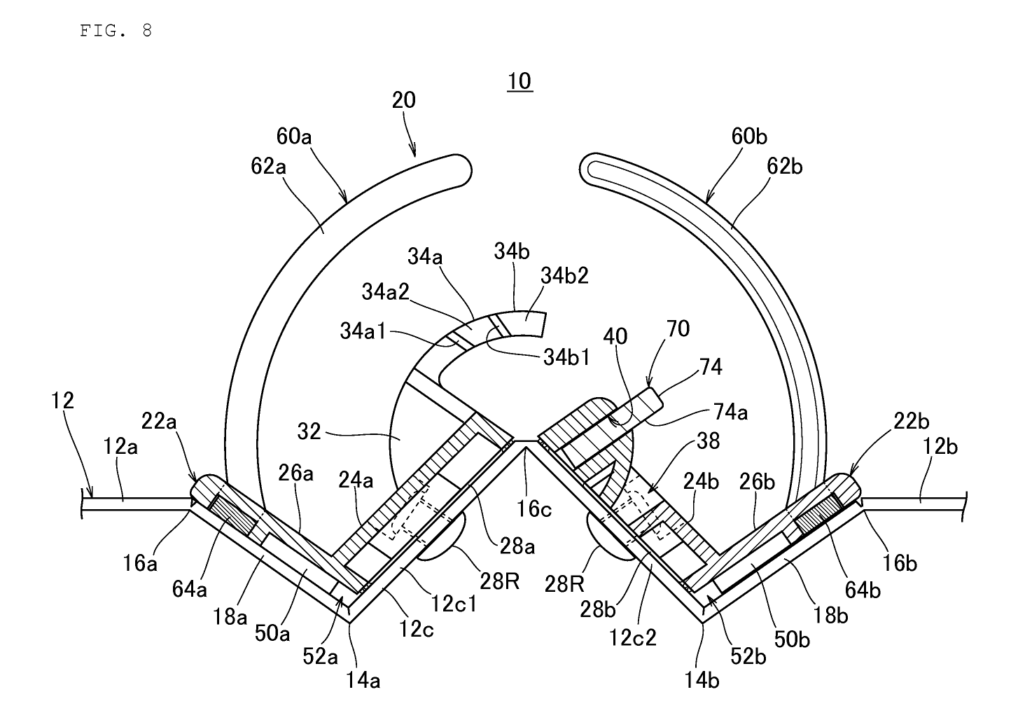

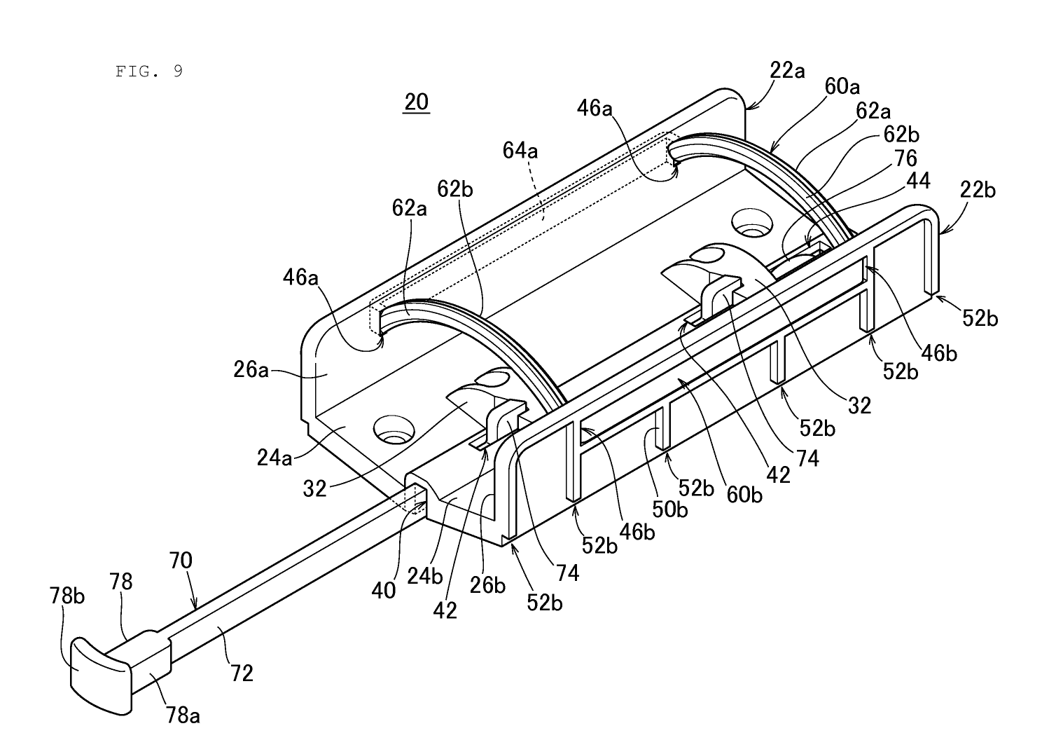

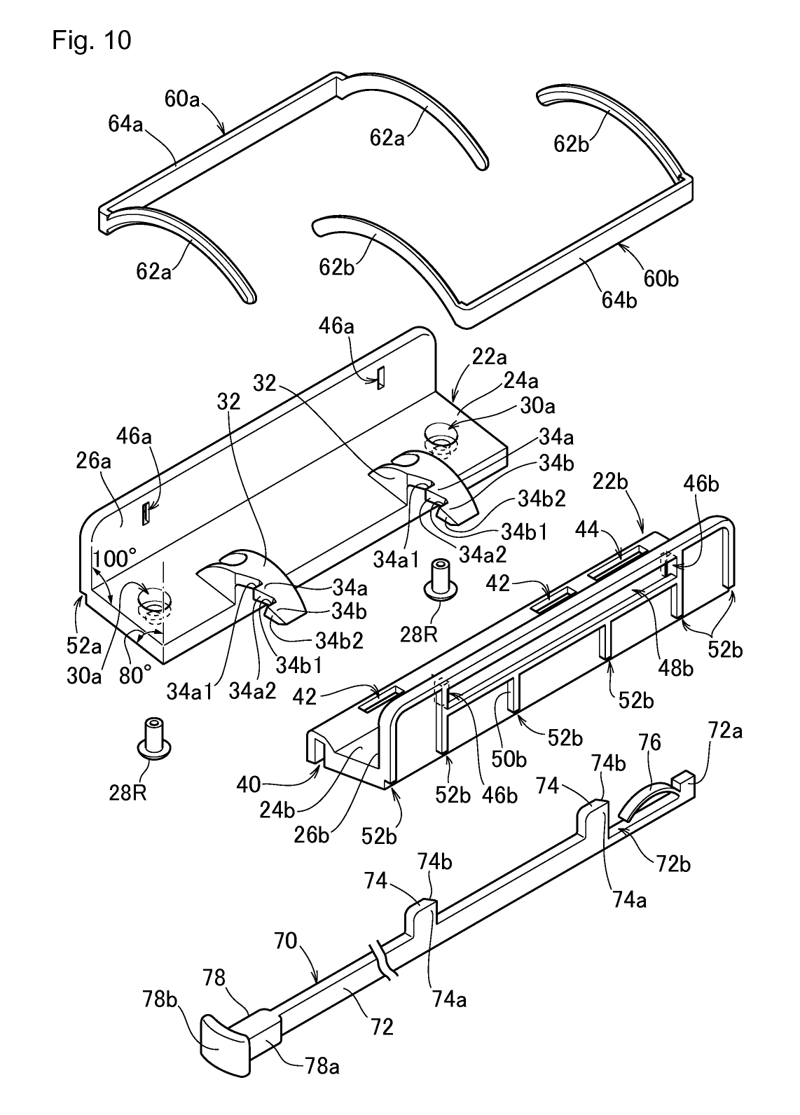

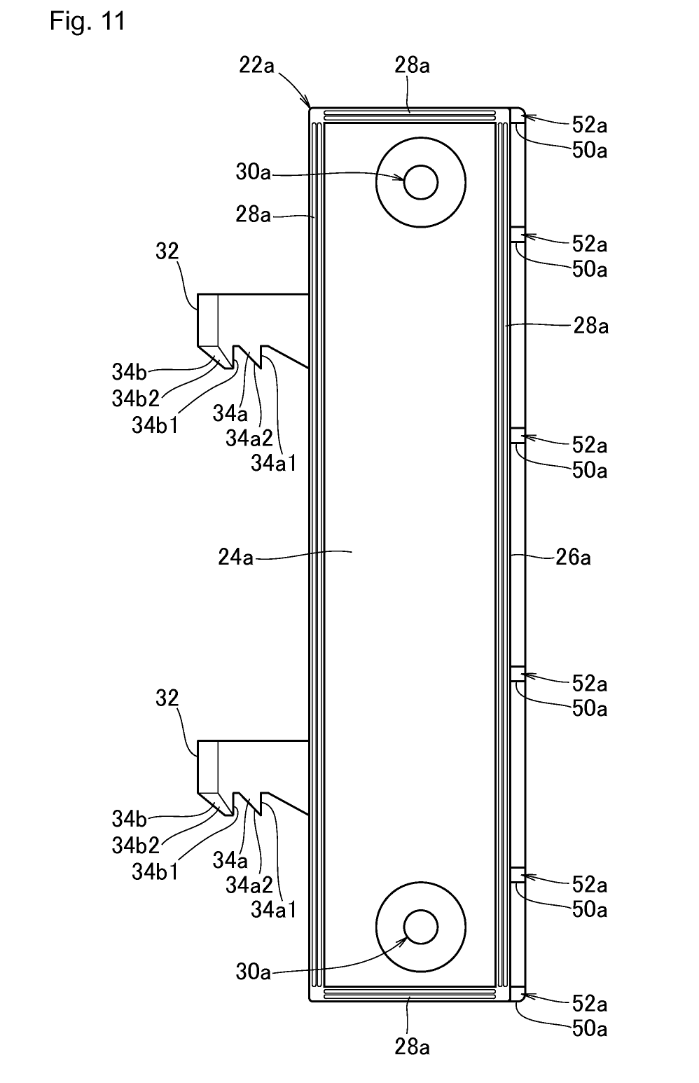

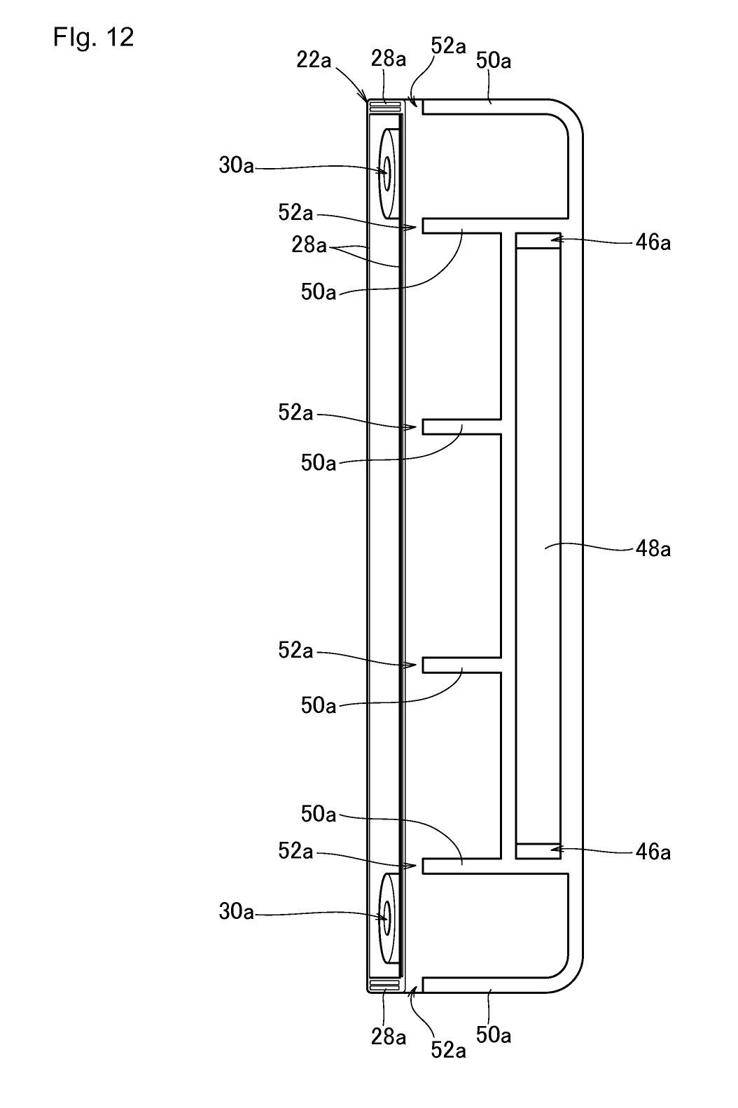

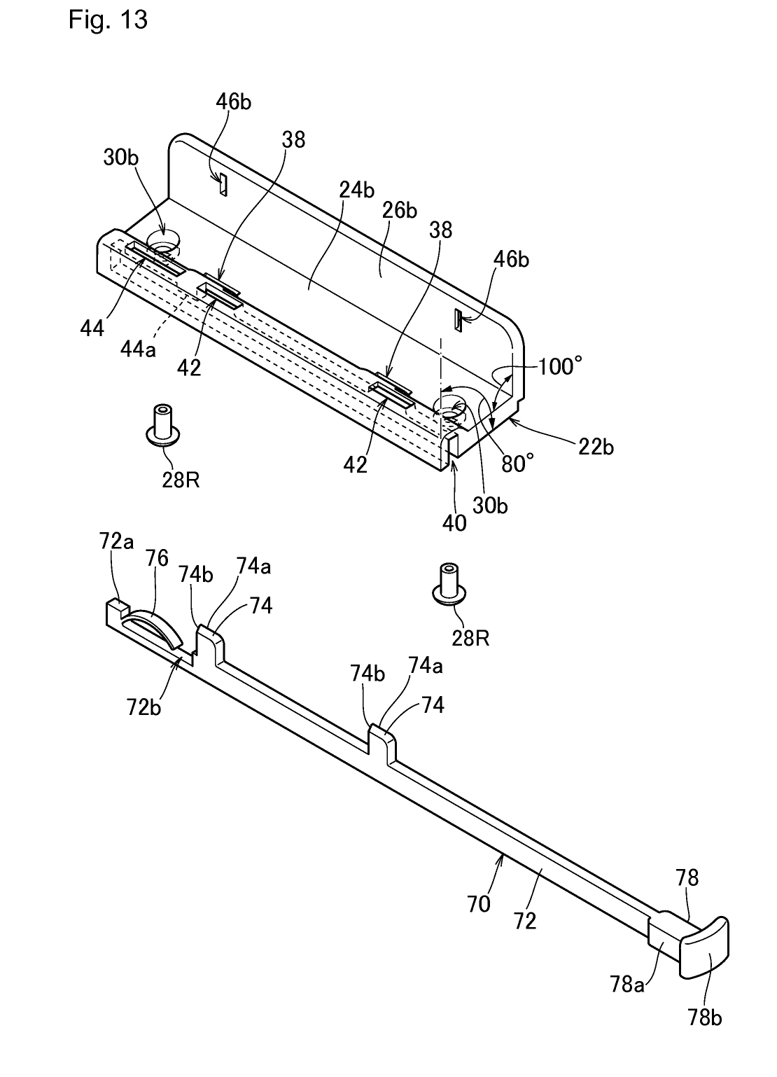

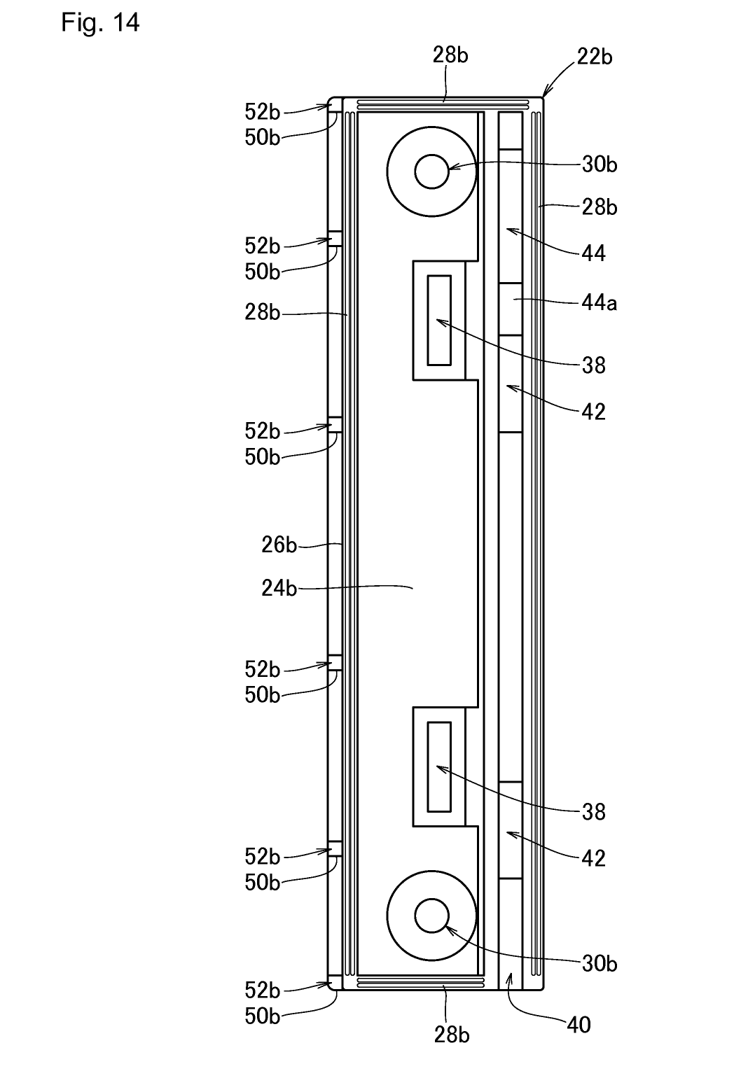

FIG. 1 is a perspective view illustrating a file including a binder device according to preferred embodiments of the present invention. FIG. 2 is a plan view of this file. FIGS. 3 and 4 are respectively plan and front views illustrating a fully closed state of the binding device of the file. FIGS. 5 and 6 are respectively plan and front views illustrating an intermediate state of the binding device of the file, the intermediate state lying between the fully closed state and a fully opened state. FIGS. 7 and 8 are respectively plan and front views illustrating the fully opened state of the binding device of the file. FIGS. 9 and 10 are, respectively, perspective and exploded perspective views of the binding device used in the file. FIGS. 11 and 12 are respectively bottom and left side views of a first main body used in the binding device. FIG. 13 is a perspective view illustrating a second main body and a lever member used in the binding device. FIG. 14 is a bottom view of the second main body used in the binding device.

The file 10 shown in FIG. 1 includes a thin cover 12 having opposite flat principal surfaces and made of a synthetic resin such as polypropylene (PP). The cover 12 includes a substantially rectangular front cover 12a and a substantially rectangular back cover 12b. The front cover 12a and the back cover 12b extend from first and second widthwise end portions, respectively, of an elongated substantially rectangular spine 12c. The front cover 12a is melt-fixed to the spine 12c through a fixing portion 14a such that the principal surface of a spine 12c-side portion (a first fixed portion 18a described later) of the front cover 12a and the principal surface of a front cover 12a-side portion (a first spine portion 12c1 described later) of the spine 12c form an angle of, for example, about 100 degrees. The fixing portion 14a is provided between the front cover 12a and the spine 12c and extends linearly from the upper end of the cover 12 to the lower end of the cover 12. Similarly, the back cover 12b is melt-fixed to the spine 12c through a fixing portion 14b such that the principal surface of a spine 12c-side portion (a second fixed portion 18b described later) of the back cover 12b and the principal surface of a back cover 12b-side portion (a second spine portion 12c2 described later) of the spine 12c form an angle of, for example, about 100 degrees. The fixing portion 14b is provided between the back cover 12b and the spine 12c and extends linearly from the upper end of the cover 12 to the lower end of the cover 12. Note that these fixing portions 14a and 14b are arranged substantially parallel to each other.

Furthermore, the front cover 12a has a thin-walled bendable portion 16a formed near the spine 12c and extending linearly from the upper end of the cover 12 to the lower end. Similarly, the back cover 12b has a thin-walled bendable portion 16b formed near the spine 12c and extending linearly from the upper end of the cover 12 to the lower end of the cover 12. In addition, the spine 12c has a thin-walled bendable portion 16c formed in the widthwise central portion thereof and extending linearly from the upper end of the cover 12 to the lower end of the cover 12. This bendable portion 16c defines a central axis when a first main body 22a, a second main body 22b, and other components of a binding device 20 described later are opened and closed. These bendable portions 16a, 16b, and 16c, as well as the fixing portions 14a and 14b, are formed substantially in parallel with each other.

In the front cover 12a, a portion between the fixing portion 14a and the bendable portion 16a is formed as the first fixed portion 18a. Similarly, in the back cover 12b, a portion between the fixing portion 14b and the bendable portion 16b is formed as the second fixed portion 18b. The first fixed portion 18a and the second fixed portion 18b extend from the upper end of the cover 12 to the lower end and have elongated substantially rectangular shapes of approximately the same size.

In addition, in the spine 12c, a portion between the fixing portion 14a and the bendable portion 16c is formed as the first spine portion 12c1, and a portion between the fixing portion 14b and the bendable portion 16c is formed as the second spine portion 12c2. The first spine portion 12c1 and the second spine portion 12c2 extend from the upper end of the cover 12 to the lower end and have elongated substantially rectangular shapes of approximately the same size.

Therefore, the first fixed portion 18a and the first spine portion 12c1 are fixed such that the principal surfaces thereof form an angle of about 100 degrees. Similarly, the second fixed portion 18b and the second spine portion 12c2 are fixed such that the principal surfaces thereof form an angle of about 100 degrees.

To manufacture this cover 12, a cover member is first formed which is composed of, for example, a synthetic resin sheet having a size and shape corresponding to those of the front cover 12a, the back cover 12b, and the spine 12c. Then, a groove having, for example, a V-shaped cross-section is formed in the cover member. Specifically, the groove is formed in each of the portions corresponding to the inner portions of the bendable portions 16a, 16b, and 16c. Thus, the thin-walled bendable portions 16a, 16b, and 16c are formed. Next, a heated knife edge is pressed against portions of the cover member corresponding to the inner portions of the fixing portions 14a and 14b to thereby melt the pressed portions. Then, the cover member is bent such that the principal surfaces on both sides of each melted portion formed by the heated knife edge form a predetermined angle (100 degrees). In this manner, the cover member is melt fixed, and the fixing portions 14a and 14b are thereby formed. The cover 12 is manufactured as described above.

As shown in FIGS. 1 and 2, the binding device 20 is secured to the inner portion of the cover 12. The binding device 20 includes the first main body 22a disposed on the inner side of the spine 12c and located on the front cover 12a-side (left side), and the second main body 22b disposed on the inner side of the spine 12c and located on the back cover 12b-side (right side). The first main body 22a and the second main body 22b are made of a synthetic resin such as polypropylene (PP) and are substantially left-right symmetric as shown in FIG. 9.

As shown in FIG. 10, the first main body 22a includes a base portion 24a having an elongated substantially rectangular shape, and the base portion 24a is configured such that its bottom surface and right side surface form an angle of, for example, about 80 degrees. Furthermore, the base portion 24a faces the first spine portion 12c1. Therefore, the base portion 24a is configured to have a width substantially the same as the width of the first spine portion 12c1 and to have a length of about one-third of the longitudinal length of the first spine portion 12c1. In addition, the base portion 24a is configured such that the external surface thereof is in close contact with the inner surface of the first fixed portion 18a of the cover 12.

This base portion 24a has an integrally formed plate-shaped side portion 26a extending upward from the left edge that faces the first fixed portion 18a of the cover 12. Since the side portion 26a faces the first fixed portion 18a of the cover 12, the side portion 26a is formed to have a width substantially the same as the width of the first fixed portion 18a and to have a length of about one-third of the longitudinal length of the first fixed portion 18a. The base portion 24a and the side portion 26a are formed such that the principal surfaces thereof form an angle of, for example, about 100 degrees.

As shown in FIG. 11, the base portion 24a has a substantially rectangular frame-shaped welded portion 28a provided on the bottom surface that faces the first spine portion 12c1. This welded portion 28a is formed by pre-forming ribs for the welded portion so as to protrude from the bottom surface of the base portion 24a and to form a substantially rectangular frame shape, pressing the ribs for the welded portion against the central portion of the first spine portion 12c1 on the left side of the bendable portion 16c from the inner side of the spine 12c, and ultrasonically welding the ribs to the central portion. Thus, the first main body 22a is secured to the central portion of the first spine portion 12c1 from the inner side of the spine 12c of the cover 12 via the welded portion 28a.

Similarly, as shown in FIG. 13, the second main body 22b includes a base portion 24b having a elongated substantially rectangular shape, and the base portion 24b is formed such that its bottom surface and left side surface form an angle of, for example, about 80 degrees. The base portion 24b is formed to have a width substantially the same as the width of the second spine portion 12c2 and to have a length of about one-third of the longitudinal length of the second spine portion 12c2. This base portion 24b has an integrally formed plate-shaped side portion 26b extending upward from the right edge that faces the second fixed portion 18b of the cover 12. The side portion 26b is formed to have a width substantially the same as the width of the second fixed portion 18b and to have a length of about one-third of the longitudinal length of the second fixed portion 18b. In addition, the side portion 26b is formed such that the external surface thereof is in close contact with the inner surface of the second fixed portion 18b of the cover 12. The base portion 24b and the side portion 26b are formed such that the principal surface of the base portion 24b and the principal surface of the side portion 26b form an angle of, for example, about 100 degrees, which corresponds to the angle between the fixed portion 18b and the spine portion 12c2 of the cover 12. As shown in FIG. 14, the base portion 24b also has a substantially rectangular frame-like welded portion 28b formed on the bottom surface that faces the second spine portion 12c2. This welded portion 28b is formed by pre-forming ribs for the welded portion so as to protrude from the bottom surface of the base portion 24b and to form a substantially rectangular frame shape, pressing the ribs for the welded portion against the central portion of the second spine portion 12c2 on the right side of the bendable portion 16c from the inner side of the spine 12c, and ultrasonically welding the ribs to the central portion.

Thus, the second main body 22b is secured to the central portion of the second spine portion 12c2 from the inner side of the spine 12c of the cover 12 through the welded portion 28b.

As described above, the first main body 22a and the second main body 22b of the binding device 20 are secured to the spine 12c of the cover 12, specifically, to the first spine portion 12c1 and the second spine portion 12c2, respectively, on both sides of the bendable portion 16c. Therefore, as shown in FIGS. 3 to 8, the first main body 22a and the second main body 22b of the binding device 20, together with the front cover 12a, back cover 12b, and spine 12c of the cover 12, can be rotatably moved, or opened and closed, about the bendable portion 16c of the spine 12c as the central axis.

Moreover, as shown in FIGS. 3 and 4, the first main body 22a and the second main body 22b are secured to the spine 12c of the cover 12 such that in their fully closed state, the right side surface of the base portion 24a and the left side surface of the base portion 24b abut against each other and the side portion 26a and the side portion 26b are substantially in parallel with each other.

As shown in FIG. 10, the base portion 24a includes two attachment holes 30a and 30a that are spaced apart from each other in the longitudinal direction of the base portion 24a and pass through the opposite principal surfaces of the base portion 24a. Similarly, as shown in FIG. 13, the base portion 24b includes two attachment holes 30b and 30b that are spaced apart from each other in the longitudinal direction of the base portion 24b and pass through the opposite principal surfaces of the base portion 24b. The first main body 22a and the second main body 22b may be fastened to the spine 12c of the cover 12 through fasteners 28R, such as rivets, by passing the fasteners 28R through the attachment holes 30a, 30a, 30b, and 30b and the spine 12c of the cover 12. When the fasteners 28R, such as rivets, are used, the ribs for the welded portions and the welded portions 28a and 28b described above need not be provided. Preferably, the base portions 24a and 24b have flat outer surfaces that are in close contact with the first spine portion 12c1 and the second spine portion 12c2, respectively.

As shown in FIGS. 3 and 10, a pair of locking members 32 and 32 spaced apart from each other in the longitudinal direction of the base portion 24a are provided on the upper portion on the right side, or the second main body 22b-side, of the base portion 24a of the first main body 22a, the locking members 32 and 32 being formed integrally with the main body 22a. The pair of locking members 32 and 32 are made of a synthetic resin, such as polypropylene (PP), and have a length corresponding to about half the width of the base portion 24a protrudes from the right edge of the base portion 24a toward the second main body 22b-side. These locking members 32 and 32 are used to hold the first main body 22a and the second main body 22b in the fully closed state, and each of the locking members 32 and 32 has an arc shape with the central axis at the bendable portion 16c of the spine 12c. In addition, each of these locking members 32 and 32 has, for example, two stepped hook portions 34a and 34b.

The first hook portion 34a preferably has aright triangular shape so as to protrude from an intermediate portion between the base portion and end portion of the locking member 32 toward a first longitudinal end side (the lower end side of the cover 12) of the first main body 22a. This hook portion 34a includes on the left side, a flat surface 34a1 parallel to the longitudinal direction of the first main body 22a and an inclined surface 34a2 on the right of the flat surface 34a1, the inclined surface 34a2 being inclined in the upper right direction. This hook portion 34a is used to hold the first main body 22a and the second main body 22b in the fully closed state.

Moreover, as with the first hook portion 34a, the second hook portion 34b preferably has a right triangular shape so as to protrude from the end portion of the locking member 32 toward the first longitudinal end side (the lower end side of the cover 12) of the first main body 22a. This hook portion 34b includes, on the left side, a flat surface 34b1 parallel to the longitudinal direction of the first main body 22a and an inclined surface 34b2 on the right of the flat surface 34b1, the inclined surface 34b2 being inclined in an upper right direction. This hook portion 34b is used to hold the first main body 22a and the second main body 22b in the intermediate state between the fully closed state and the fully opened state.

Note that these hook portions 34a and 34b are not used when the first main body 22a and the second main body 22b are in the fully opened state.

As shown in FIGS. 3 and 13, two holes for the locking member 38 and 38 are provided in the base portion 24b of the second main body 22b so as to be spaced apart from each other in the longitudinal direction of the base portion 24b. These holes for the locking member 38 and 38 are arranged so as not to interfere with the inward and outward motion of the locking members 32 and 32 when the first main body 22a and the second main body 22b are opened and closed. These holes for the locking member 38 and 38 are disposed at locations corresponding to the locking members 32 and 32.

Moreover, as shown in FIGS. 10 and 13, the base portion 24b of the second main body 22b includes a thick-walled portion on the left side, or the first main body 22a-side, of the holes for the locking member 38 and 38. A groove for the sliding portion 40 having a substantially rectangular cross-section is provided in the lower portion of the thick-walled portion so as to extend substantially linearly from the first longitudinal end of the thick-walled portion to near the second longitudinal end. Moreover, the base portion 24b has two holes for the engagement portion 42 and one hole for the spring portion 44 which are arranged so as to be spaced apart from one another and to be in communication with the groove for the sliding portion 40 at the upper portion of the groove for the sliding portion 40. In this configuration, each of the two holes for the engagement portion 42 have a elongated shape and are arranged at locations including the locations corresponding to the hook portions 34a and 34b of the two locking members 32 and 32. The hole for the spring portion 44 is arranged closer to the second longitudinal end of the base portion 24b (the upper end of the cover 12) than the two holes for the engagement portion 42. In addition, the base portion 24b includes a downward protrusion 44a disposed between the hole for the spring portion 44 and an adjacent one of the holes for the engagement portion 42.

As shown in FIG. 10, the side portion 26a of the first main body 22a includes two holes for the prong 46a and 46a which are spaced apart from each other in the longitudinal direction of the side portion 26a and arranged at a midpoint in the height direction so as to pass through the left and right surfaces (the opposite principal surfaces) of the side portion 26a. The two holes for the prong 46a are provided for inserting two prongs 62a of a first prong member 60a described later. As shown in FIG. 12, this side portion 26a is a left side portion facing the first fixed portion 18a of the cover 12 and has a recess for the connection portion 48a disposed at a midpoint in the height direction of the side portion 26a so as to extend substantially linearly between the two holes for the prong 46a in the longitudinal direction. The recess for the connection portion 48a is provided to be fit with a connection portion 64a of the first prong member 60a described later. Moreover, a lattice-shaped reinforcing rib 50a is provided on the left surface of the side portion 26a. An end surface of this reinforcing rib 50a has a flat shape and comes into surface contact with the flat inner surface of the first fixed portion 18a of the cover 12. In addition, in order to prevent the reinforcing rib 50a from coming into contact with the fixing portion 14a of the cover 12, notch portions 52a for the fixing portion are formed in the lower portion of the reinforcing rib 50a.

Similarly, as shown in FIGS. 10 and 13, the side portion 26b of the second main body 22b includes two holes for the prong 46b and 46b which are spaced apart from each other in the longitudinal direction of the side portion 26b and disposed at a midpoint in the height direction so as to pass through the left and right surfaces (the opposite principal surfaces) of the side portion 26b. The two holes for the prong 46b are provided for inserting two prongs 62b of a second prong member 60b described later. In this configuration, when viewed from a direction parallel to the central axis, e.g., from the longitudinal direction of the side portion 26b, the two holes for the prong 46b are spaced apart from each other by a smaller distance than the two holes for the prong 46a provided in the side portion 26a of the first main body 22a. Specifically, the two holes for the prong 46b are disposed in an inner region between the two holes for the prong 46a so as to be interposed between the two holes for the prong 46a. As shown in FIG. 10, the side portion 26b is a right side portion facing the second fixed portion 18b of the cover 12 and includes a recess for the connection portion 48b at a midpoint in the height direction of the side portion 26b so as to extend substantially linearly between the two holes for the prong 46b and 46b in the longitudinal direction. The recess for the connection portion 48b is provided for fitting a connection portion 64b of the second prong member 60b described later. Moreover, a lattice-shaped reinforcing rib 50b is also provided on the right surface of the side portion 26b. An end surface of this reinforcing rib 50b has a flat shape and comes into surface contact with the flat inner surface of the second fixed portion 18b of the cover 12. In addition, in order to prevent the reinforcing rib 50b from coming into contact with the fixing portion 14b of the cover 12, notch portions 52b are also provided in the lower portion of the reinforcing rib 50b.

The first prong member 60a is mounted to the first main body 22a. The first prong member 60a is made of a metal, such as stainless steel, and has a substantially U-shape. As shown in FIG. 10, the prong member 60a includes the two prongs 62a made of a metal and formed into an arc shape. The two prongs 62a are formed integrally with the metal linear connection portion 64a so as to extend from opposite sides of the connection portion 64a, and the two prongs 62a together with the connection portion 64a form the substantially U-shape. In this configuration, the two prongs 62a are arranged so as to be spaced apart from each other by a distance corresponding to the distance between the two holes for the prong 46a. Moreover, the connection portion 64a is formed into a shape corresponding to the shape of the recess for the connection portion 48a. The prong member 60a is formed by punching a metal plate into a predetermined shape by, for example, press working and molding the punched plate into a predetermined shape.

This prong member 60a can be easily mounted to the first main body 22a by inserting the two prongs 62a into the two holes for the prong 46a from the left side of the side portion 26a of the first main body 22a and fitting the connection portion 64a in the recess for the connection portion 48a. Note that each of the two prongs 62a extends from the first fixed portion 18a-side of the cover 12 toward the second fixed portion 18b-side and is formed into an arc shape that is convex toward a side opposite to the spine 12c-side with the central axis at the bendable portion 16c of the spine 12c.

Similarly, the second prong member 60b having a structure similar to the structure of the first prong member 60a is also mounted to the second main body 22b. The two arc-shaped prongs 62b of this prong member 60b are formed so as to be spaced apart from each other by a distance corresponding to the distance between the two holes for the prong 46b. The connection portion 64b is formed into a shape corresponding to the shape of the recess for the connection portion 48b.

This prong member 60b can be easily mounted to the second main body 22b by inserting the two prongs 62b into the two holes for the prong 46b from the right side of the side portion 26b of the second main body 22b and fitting the connection portion 64b in the recess for the connection portion 48b. Note that each of the prongs 62b extends from the second fixed portion 18b-side of the cover 12 toward the first fixed portion 18a-side and is formed into an arc-like shape convex toward a side opposite to the spine 12c-side with the central axis at the bendable portion 16c of the spine 12c.

Moreover, these prongs 62b are formed so as to overlap the opposing inner surfaces of the prongs 62a when the first main body 22a and second main body 22b of the binding device 20 are closed. Each of the prongs 62a is formed to have a trapezoidal cross-section such that the prongs 62a form a hexagonal cross-section when these prongs overlap each other in the manner described above.

In this binding device 20, two sets of the prong 62a and prong 62b that overlap each other are provided when the first main body 22a and the second main body 22b are closed. Thus, objects to be bound, such as paper sheets, are bound by passing the two sets of the prong 62a and prong 62b overlapping each other through two binding holes formed in the objects to be bound. In this case, each set of the prong 62a and prong 62b is inserted through a corresponding one of the binding holes.

Moreover, the prong 62a and the prong 62b have arc shapes of the same radius with respect to the central axis at the bendable portion 16c of the spine 12c. Thus, when the first main body 22a and the second main body 22b are opened or closed about the bendable portion 16c as the central axis, the prongs 62a and 62b move rotationally along respective arcs of the same radius with respect to the central axis at the bendable portion 16c. Therefore, the prongs 62a and 62b are less likely to break the binding holes of the bound objects.

Furthermore, each of the prongs 62a and prongs 62b has an arc shape that is convex toward a side opposite to the spine 12c-side. Therefore, when the first main body 22a and the second main body 22b are slightly opened, the objects bound with the prongs 62a and 62b are easily turned over along the prongs 62a and 62b.

Moreover, each of the prongs 62a and 62b is provided so as to be spaced apart from the spine 12c through the holes for the prong 46a and 46b provided in the side portions 26a and 26b of the main bodies 22a and 22b, respectively, and through other components. The distance between the spine 12c and each of the prongs 62a and 62b is designed so as to correspond to the distance between each binding hole and the edge of objects to be bound. Accordingly, the objects can be bound such that their portions between the edge and each binding hole are held between the spine 12c and the prongs 62a and 62b without being bent.

Furthermore, a lever member 70 made of a synthetic resin, such as polyacetal (POM), is slidably provided in the second main body 22b. The lever member 70 is used when the first main body 22a and the second main body 22b are opened and includes a rod-like sliding portion 72, as shown in FIGS. 10 and 13. The sliding portion 72 has a substantially rectangular cross-sectional shape similar to the cross-sectional shape of the groove for the sliding portion 40 in the second main body 22b.

A portion of this sliding portion 72 which includes a portion extending from its longitudinal center to its second longitudinal end and does not include its first longitudinal end portion is fitted in the groove for the sliding portion 40, and therefore the sliding portion 72 is provided slidably along the longitudinal direction of the groove for the sliding portion 40. In this configuration, the first longitudinal end of the sliding portion 72 is disposed on the lower end side of the cover 12, and the second longitudinal end of the sliding portion 72 is disposed at a midpoint between the upper and lower ends of the cover 12.

Two plate-like engagement portions 74 are provided in the upper portions of the longitudinal central and second end side portions of the sliding portion 72 so as to be spaced apart from each other by approximately the same distance as the distance between the two holes for the engagement portion 42. These engagement portions 74 are disposed so as to protrude upwardly from the two holes for the engagement portion 42.

In order to allow these engagement portions 74 to move within the holes for the engagement portion 42 in the longitudinal direction of the groove for the sliding portion 40 and sliding portion 72, these engagement portions 74 are configured to have a length shorter than the length between the hole for the engagement portion 42 and a hole for the engagement portion 42, when viewed from the longitudinal direction of the groove for the sliding portion 40 and sliding portion 72. In this configuration, these engagement portions 74 are configured such that the hook portions 34a and 34b of the two locking members 32 are disengaged from the engagement portions 74 when the engagement portions 74 are moved toward the first longitudinal end side (the lower end side of the cover 12) of the holes for the engagement portion 42. In addition, the engagement portions 74 are arranged such that the hook portions 34a or 34b of the two locking members 32 can be engaged with the engagement portions 74 when the engagement portions 74 are moved toward the second longitudinal end side (the upper end side of the cover 12) of the holes for the engagement portion 42.

Moreover, in order to prevent the hook portions 34a and 34b from being accidentally disengaged from the end portions of these engagement portions 74, the engagement portions 74 have flat surfaces 74a that are substantially parallel to the longitudinal direction of the sliding portion 72. The flat surfaces 74a are provided on the right side of the end portions that abut against the flat surfaces 34a1 or 34b1 of the hook portions 34a or 34b, respectively, when the hook portions 34a or 34b are engaged with the end portions.

Furthermore, these engagement portions 74 have inclined surfaces 74b and 74b inclined in the upper right direction in order to facilitate the engagement of the hook portions 34a and 34b with the end portions. The inclined surfaces 74b and 74b are provided on the end surfaces of the end portions that come into contact with the inclined surfaces 34a2 and 34b2, which are also inclined in the upper right direction, of the hook portions 34a and 34b when the hook portions 34a and 34b are brought into engagement with the end portions.

Moreover, a spring portion 76 having, for example, a curved plate-like shape is integrally provided in the second longitudinal end portion of the sliding portion 72. In this configuration, a recess 72b is provided in the upper portion of the second longitudinal end portion of the sliding portion 72, the recess being located on the central side of a rectangular parallelepiped end portion 72a. The spring portion 76 extends from the end portion 72a to the inside of the recess 72b and has an arc shape that is convex upwardly on the upper side so as to have spring characteristics. This spring portion 76 is inserted into the hole for the spring portion 44 provided in the second main body 22b, and the end of the spring portion 76 abuts the protrusion 44a that protrudes downward in order to define the first longitudinal side portion of the hole for the spring portion 44 in the main body 22b. The sliding portion 72 is urged by this spring portion 76 in one direction toward the second longitudinal end side (the upper end side of the cover 12) of the groove for the sliding portion 40 provided in the second main body 22b such that the hook portions 34a and 34b of the two locking members 32 can be brought into engagement with the engagement portions 74.

A knob portion 78 is provided at the first longitudinal end portion of the sliding portion 72. The knob portion 78 is arranged on the inner side of the spine 12c, specifically on the lower end side of the cover 12. The knob portion 78 includes a body portion 78a having a width greater than the width of the sliding portion 72. A hook piece 78b having a curved plate shape and protruding in three directions, i.e., right, left, and upward directions, is provided at the end portion of the body portion 78a. This knob portion 78 is grasped in order to disengage the hook portions 34a and 34b of the two locking members 32 from the engagement portions 74. The knob portion 78 is grasped in order to cause the sliding portion 72 to slide in a direction opposite to the one direction, i.e., a direction from the second longitudinal end side of the groove for the sliding portion 40 to the first longitudinal end side (from the upper end side of the cover 12 to the lower end side), against the urging force of the spring portion 76.

The sliding portion 72, the engagement portions 74, the spring portion 76, and the knob portion 78 of the lever member 70 are integrally formed of a synthetic resin. This lever member 70 can be easily mounted by fitting it into the second main body 22b before the second main body 22b is secured to the spine 12c.

In file 10, the binding device 20 includes the first main body 22a, the second main body 22b, the first prong member 60a, the second prong member 60b, and the lever member 70. Therefore, a small number of components are necessary to define the binding device 22. Accordingly, the binding device 22 and the file 10 can be easily manufactured and can be manufactured at low cost.

To face the first spine portion 12c1, the base portion 24a has a width substantially the same as the width of the first spine portion 12c1 and a length less than the longitudinal length of the first spine portion 12c1. The base portion 24a is integrally provided with the plate-shaped side portion 26a such that the side portion 26a faces a portion of the front cover 12a which is in proximity to the spine 12c. The second main body 22b of the binding device includes the base portion 24b having an elongated substantially rectangular plate shape. To face the second spine portion 12c2, the base portion 24b has a width substantially the same as the width of the second spine portion 12c2 and a length less than the longitudinal length of the second spine portion 12c2. The base portion 24b is integrally provided with the plate-shaped side portion 26b such that the side portion 26b faces a portion of the back cover 12b which is in proximity to the spine 12c. The first main body 22a and the second main body 22b of the binding device are secured to the first spine portion 12c1 and the second spine portion 12c2, respectively, on both sides of the bendable portion of the spine 12c of the cover 12. Accordingly, the cover 12 is reinforced by the first main body 22a and second main body 22b of the binding device, and therefore, the thickness of the cover 12 can be reduced so as to reduce the weight.

Moreover, the spine 12c includes the thin bendable portion 16c in the central portion in the width direction thereof and extending linearly from the upper end of the cover 12 to the lower end.

The front cover 12a has the thin bendable portion 16a provided in proximity to the spine 12c and extending linearly from the upper end of the cover 12 to the lower end, and a portion between the bendable portion 16a and the boundary between the front cover 12a and the spine 12c is provided as the first fixed portion 18a. The back cover 12b has the thin bendable portion 16b provided in proximity to the spine 12b and extending linearly from the upper end of the cover 12 to the lower end, and a portion between the bendable portion 16b and the boundary between the back cover 12b and the spine 12c is provided as the second fixed portion 18b. Therefore, since the side portion of the first main body 22a is provided along the first fixed portion 18a, the shape formed by the first fixed portion 18a and the first spine portion 12c1 can be maintained for a long period of time. In addition, since the side portion of the second main body 22b is provided along the second fixed portion 18b, the shape formed by the second fixed portion 18b and the second spine portion 12c2 can be maintained for a long period of time.

When the cover 12 is opened and closed, the side portion thereof extending from the bendable portion 16a is opened and closed. Therefore, the shape formed by the first fixed portion 18a and the first spine portion 12c1 and the shape formed by the second fixed portion 18b and the second spine portion 12c2 are not affected by the opening and closing operation. Accordingly, the predetermined shape of the cover can be maintained for a long period of time.

The base portion 24a of the first main body 22a is fastened to the inner surface of the first spine portion 12c1 by the fasteners 28R, and the base portion 24b of the second main body 22b is fastened to the inner surface of the second spine portion 12c2 by the fasteners 28R. Therefore, the first spine portion 12c1 is reinforced by the first main body 22a, and the second spine portion 12c2 is reinforced by the second main body 22b. Accordingly, even when the cover is made of a relatively thin material to reduce the weight in order to facilitate handing, a rigid file can be obtained.

The reinforcing rib 50a of the side portion 26a of the first main body 22a is arranged so as to come into close contact with the first fixed portion 18a of the front cover 12a, and the reinforcing rib 50b of the side portion 26b of the second main body 22b is arranged so as to come into close contact with the second fixed portion 18b of the back cover 12b. Therefore, since the side portion 26a of the first main body 22a is provided along the first fixed portion 18a, the shape formed by the first fixed portion 18a and the first spine portion 12c1 can be maintained for a long period of time. In addition, since the side portion 26b of the second main body 22b is provided along the second fixed portion 18b, the shape formed by the second fixed portion 18b and the second spine portion 12c2 can be maintained for a long period of time.

When the cover 12 is opened and closed, the side portion thereof extending from the bendable portion 16a is opened and closed. Therefore, the shape formed by the first fixed portion 18a and the first spine portion 12c1 and the shape formed by the second fixed portion 18b and the second spine portion 12c2 are not affected by the opening and closing operation. Accordingly, the predetermined shape of the cover can be maintained for a long period of time.

In this file 10, the first prong member 60a and the second prong member 60b of the binding device 20 are each formed into the substantially U-shape. Specifically, the two arc-shaped prongs 62a and 62a and the two arc-shaped prongs 62b and 62b extend from the opposite ends of the single linear connection portion 64a and the single linear connection portion 64b, respectively. The first prong member 60a is mounted to the first main body 22a by inserting the two prongs 62a and 62a of the first prong member 60a into the two holes for the prong 46a and 46a provided in the first main body 22a. In addition, the second prong member 60b is mounted to the second main body 22b by inserting the two prongs 62b and 62b of the second prong member 60b into the two holes for the prong 46b and 46b provided in the second main body 22b. Accordingly, when the binding device 20 is assembled, the locations of the prongs 62a and 62a relative to the first main body 22a are easily adjusted, and the locations of the prongs 62b and 62b relative to the second main body 22b are easily adjusted. In addition, since the connection portions 64a and 64b of the prong members 60a and 60b are fitted in the recesses for the connection portion 48a and 48b, respectively, they do not protrude and are not obstacles.

Moreover, in this file 10, the lever member 70 of the binding device 20 includes the sliding portion 72, the engaging portions 74 and 74, the spring portion 76, and the knob portion 78, and these are formed integrally of a synthetic resin. Therefore, the number of components is reduced to less than that when the sliding portion, spring portion, and other components of the lever member are formed separately. Accordingly, the lever member 70, the binding device 20, and the file 10 are easily assembled and can be manufactured at low cost.

Furthermore, in this file 10, the right side surface of the first main body 22a and the left side surface of the second main body 22b abut against each other in the fully closed state of the first main body 22a and the second main body 22b of the binding device 20. The angle between the right side surface of the first main body 22a and the bottom surface of the first main body 22a which faces the first spine portion 12c1 is an acute angle, for example, about 80 degrees, and the angle between the left side surface of the second main body 22b and the bottom surface of the second main body 22b which faces the second spine portion 12c2 is an acute angle, for example, about 80 degrees. Therefore, when the front cover 12a and the back cover 12b of the cover 12 are fully closed, i.e., when the first main body 22a and the second main body 22b are fully closed, the widthwise central portion of the spine 12c protrudes outwardly. Accordingly, the width of the cover 12 is reduced to less than the actual width of the spine 12c, and thus, the file 10 as a space saving design.

Moreover, in the file 10, the above-described angles are each about 80 degrees. In addition, the angle between the principal surfaces of the portions (the first spine portion 12c1 and the first fixed portion 18a) on both sides of the fixing portion 14a of the cover 12 and the angle between the principal surfaces of the portions (the second spine portion 12c2 and the second fixed portion 18b) on both sides of the fixing portion 14b of the cover 12 are each about 100 degrees, which is the supplementary angle of about 80 degrees. Accordingly, when the front cover 12a and the back cover 12b of the cover 12 are fully closed, the front cover 12a and the back cover 12b are parallel to each other, which further improves the space saving design of the file 10.

As shown in FIGS. 3 and 4, in this file 10, the first main body 22a and second main body 22b of the binding device 20 can be held in the fully closed state by bringing the hook portions 34a and 34a of the two locking members 32 into engagement with the engagement portions 74 of the lever member 70. In this case, each engagement portion 74 is urged toward the hook portion 34a-side by the spring portion 76, and the flat surface 34a1 of the hook portion 34a and the flat surface 74a of the engagement portion 74, which come in contact with each other, are arranged so as to be substantially perpendicular to the extending direction of the locking member 32, i.e., the open-close direction of the locking member 32. Accordingly, the hook portion 34a is less likely to be accidentally disengaged from the engagement portion 74. Thus, the first main body 22a and the second main body 22b of the binding device 20 are less likely to be accidentally opened.

Moreover, as shown in FIGS. 5 and 6, in this file 10, the first main body 22a and the second main body 22b of the binding device 20 can be held in the intermediate state between the fully closed state and the fully opened state by bringing the hook portion 34b and 34b of the two locking members 32 and 32 into engagement with the engagement portions 74 of the lever member 70. When the first main body 22a and the second main body 22b are held in this intermediate state, objects, such as paper sheets, bound with the prongs 62a and 62b are loosened. Therefore, the bound objects, such as paper sheets, are easily turned over. Thus, information on the front and back surfaces of the bound objects can be easily read.

Furthermore, in this file 10, the hook portions 34b of the two locking members 32 are arranged at predetermined locations so that each of the first main body 22a and the second main body 22b of the binding device 20 is opened about 10 degrees in the above intermediate state. Therefore, this file 10 is configured such that the bottom surface of the first main body 22a of the binding device 20 which faces the first spine portion 12c1 and the bottom surface of the second main body 22b which faces the second spine portion 12c2 are substantially in the same plane. Accordingly, the binding device 20 and also the file 10 can be disposed on a flat surface stably.

Each engagement portion 74 is urged toward the hook portion 34b-side by the spring portion 76, and the flat surface 34b1 of the hook portion 34b and the flat surface 74a of the engagement portion 74, which come in contact with each other, are arranged so as to be substantially perpendicular to the extending direction of the locking member 32, i.e., the open-close direction of the locking member 32. Therefore, in the intermediate state, the hook portion 34b is less likely to be accidentally disengaged from the engagement portion 74. Accordingly, the first main body 22a and the second main body 22b of the binding device 20 are less likely to be accidentally opened to a greater extent.

Moreover, as shown in FIGS. 7 and 8, in this file 10, the first main body 22a and the second main body 22b of the binding device 20 can be held in the fully opened state by disengaging the engagement portions 74 of the lever member 70 from the hook portions 34a and the hook portions 34b of the two locking members 32.

As described above, in order to disengage the engagement portions 74 of the lever member 70 from the hook portions 34a and hook portions 34b of the two the locking members 32, the knob portion 78 is grasped so that the sliding portion 72 is slid in a direction opposite to the one direction (the direction toward the lower end side of the cover 12) against the urging force of the spring portion 76, and then the first main body 22a and the second main body 22b are opened.

Conversely, in order to bring the hook portions 34a or hook portions 34b of the two locking members 32 into engagement with the engagement portions 74 of the lever member 70, the first main body 22a and the second main body 22b are closed against the urging force of the spring portion 76, whereby the engagement is made. In this case, the inclined surfaces 34a2 and 34b2 and the inclined surface 74b are formed in the hook portions 34a and 34b and the engagement portion 74, respectively. Therefore, the sliding portion 72 slides in the direction opposite to the one direction (the direction toward the lower end side of the cover 12) without pulling the sliding portion 72 to cause it to slide in the direction opposite to the one direction against the urging force of the spring portion 76 by grasping the knob portion 78. Accordingly, the first main body 22a and the second main body 22b can be easily closed.

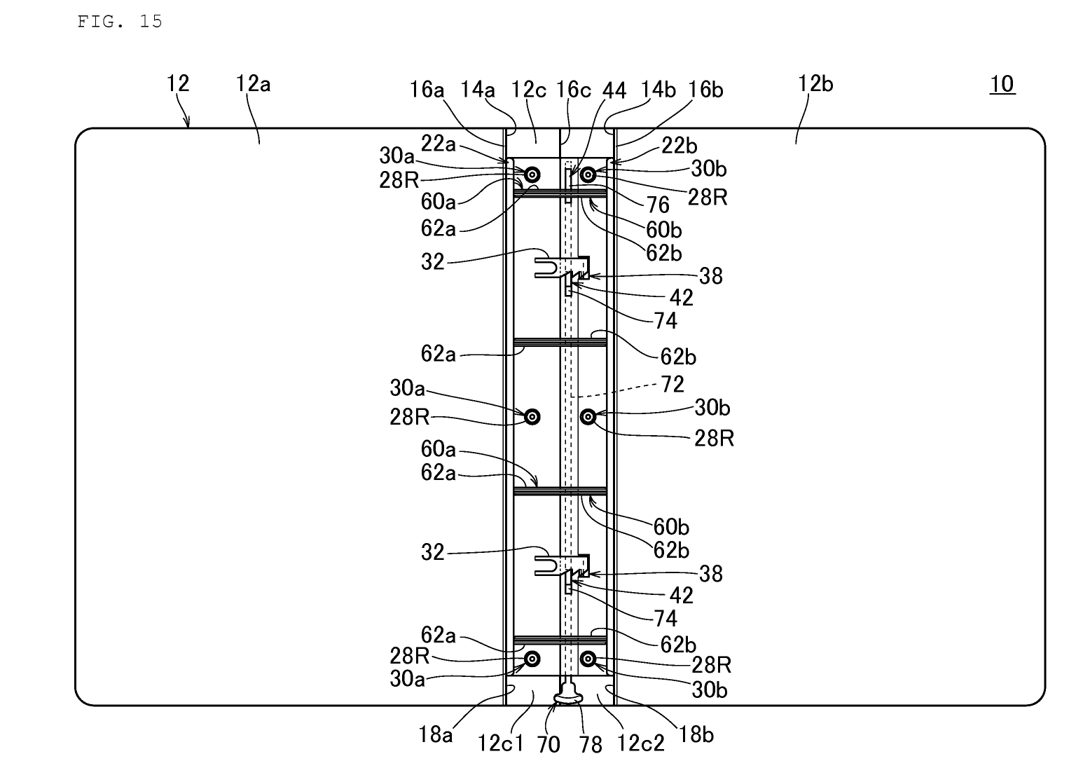

FIG. 15 is a plan view illustrating another preferred embodiment of a file. In contrast to the file 10 shown in FIG. 1, in the file 10 shown in FIG. 15, each of the first main body 22a and the second main body 22b is configured to have a length substantially the same as the length between the vicinity of the upper end of the cover 12 and the vicinity of the lower end. Moreover, two sets of the prong members 60a and two sets of the prong members 60b are mounted to the first main body 22a and the second main body 22b, respectively, in the manner similar to that in the file 10 shown in FIG. 1. Note that four sets of the prong 62a and prong 62b composed of the two sets of the prong members 60a and the two sets of the prong members 60b are disposed at regular intervals. Moreover, the first main body 22a and the second main body 22b include two sets of the locking member 32, the hole for the locking member 38, and the hole for the engagement portion 42, each of the sets being arranged in the central portion of a corresponding one of the sets of the prong members 60a and the prong members 60b. Note that the second main body 22b has the hole for the spring portion 44 provided on the upper end side of the cover 12. Moreover, the lever member 70 has a sliding portion 72 having a length corresponding to the length of the second main body 22b and two engagement portions 74 and a spring portion 76 arranged at locations corresponding to the two holes for the engagement portion 42 and the hole for the spring portion 44, respectively. Note that the first main body 22a and the second main body 22b include three attachment holes 30a and three attachment holes 30b, respectively, arranged at regular intervals.

Although the file 10 shown in FIG. 1 is used as a two-hole file, the file 10 shown in FIG. 15 is used as a four-hole file.

In each of the above-described preferred embodiments, each of the cover 12, the main bodies 22a and 22b of the binding device 20, the prong members 60a and 60b, and the lever member 70 have a specific shape or a specific structure. However, these have different shapes or structures.

For example, the front cover 12a and the back cover 12b of the cover 12 may have a horizontally elongated shape. Each of the main bodies 22a and 22b may have a block shape. Conversely, the main body 22a may be mounted to the second spine portion 12c2, and the main body 22b may be mounted to the first spine portion 12c1. Each of the prongs 62a and 62b may have a substantially semicircular cross-section such that the prongs 62a and 62b form a substantially circular cross-section when overlapped with each other. Moreover, the prongs 62a and 62b may be spaced apart from each other so as not to overlap each other, and each of the prongs 62a and 62b may be configured so as to be inserted through a respective one of the binding holes provided in objects to be bound, such as paper sheets.

Furthermore, the lever member 70 may be configured such that the hook portion is disengaged from the engagement portion not by pulling the lever member 70 but by pushing it.

Moreover, the mechanism, such as the lever member 70, that provides engagement with the locking member 32 may be provided on the first main body 22a-side, and the locking member 32 may be provided on the second main body 22b-side.

Furthermore, in each of the above-described preferred embodiments, each of the angle between the principal surfaces on both sides of the fixing portion 14a (14b) of the cover 12, the angle between the side surface and bottom surface of the main body 22a (22b), and the angle between the principal surfaces of the base portion 24a (24b) and side portion 26a (26b) of the main body 22a may be changed to any suitable angle.

Moreover, in each of the above-described preferred embodiments, the two locking members 32 are provided. However, one or three or more locking members may be provided.

Furthermore, in each of the above-described preferred embodiments, the two hook portions 34a and 34b are provided in each locking member 32, and the two hook portions 34a and 34b are used for the fully closed state and intermediate state of the binding device 20. However, one or three or more hook portions, instead of the two hook portions, may be provided in each locking member.

When one hook member is provided, the hook member may be used for the fully closed state of the binding device. In addition, when three or more hook portions are provided, these hook portions may be used for the fully closed state and two or more intermediate states of the binding device.

The binding device according to preferred embodiments of the present invention is applicable to binding devices for multi-hole files and binders such as two-hole and four-hole files and binders.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-5. (canceled)

6: A file comprising:
a cover; and
a binding device secured to the cover; wherein
the cover includes a thin spine, a thin front cover provided on a first end side in a width direction of the spine with a first fixing portion interposed therebetween, and a thin back cover provided on a second end side in the width direction of the spine with a second fixing portion interposed therebetween;
the front cover and the spine being fixed to each other through the first fixing portion so as to form a predetermined angle therebetween, the back cover and the spine being fixed to each other through the second fixing portion so as to form a predetermined angle therebetween;
the spine being bendable at an intermediate portion in the width direction thereof, the front cover being bendable at a portion in proximity to the spine, the back cover being bendable at a portion in proximity to the spine;
the binding device includes a first main body disposed on an inner side of the spine and located on a front cover side of the spine, and a second main body disposed on the inner side of the spine and located on a back cover side of the spine;
the first main body of the binding device includes an elongated substantially rectangular plate-shaped first base portion, and a first side-portion integrally provided with the first base portion;
the first base portion has a width substantially the same as a width of the first spine portion and a length less than a length of the first spine portion so as to face the first spine portion;
the first side-portion faces a portion of the front cover, the portion of the front cover being in proximity to the spine, the first side-portion has a plate shape so as to be adjusted to an angle formed between the spine and the front cover;
the second main body of the binding device includes an elongated substantially rectangular plate-shaped second base portion, and a second side-portion integrally provided with the second base portion;
the second base portion has a width substantially the same as a width of the second spine portion and a length less than a longitudinal length of the second spine portion so as to face a second spine portion;
the second side-portion faces a portion of the back cover, the portion being in proximity to the spine, the second side-portion has a plate shape so as to be adjusted to an angle formed between the spine and the back cover; and
the first main body and the second main body of the binding device are secured to the first spine portion and the second spine portion, respectively, on both sides of a bendable portion of the spine of the cover.

7: The file according to claim 6, wherein
the spine includes a thin bendable portion provided in a central portion in the width direction thereof and extending linearly from an upper end of the cover to a lower end of the cover;
the front cover includes a thin first bendable portion provided in proximity to the spine and extending linearly from the upper end of the cover to the lower end of the cover, a portion between the first bendable portion and a boundary between the front cover and the spine defining a first fixed portion; and
the back cover includes a thin second bendable portion provided in proximity to the spine and extending linearly from the upper end of the cover to the lower end of the cover, a portion between the second bendable portion and a boundary between the back cover and the spine defining a second fixed portion.

8: The file according to claim 6, wherein
the first base portion of the first main body is fastened to an inner surface of the first spine portion with a fastener; and the second base portion of the second main body is fastened to an inner surface of the second spine portion with a fastener.

9: The file according to claim 7, wherein
the first side-portion of the first main body is in close contact with the first fixed portion of the front cover; and
the second side-portion of the second main body is in close contact with the second fixed portion of the back cover.

10: The file according to claim 6, wherein the binding device comprises:
the first main body secured on the inner side of the spine so as to be located on a first side of a central portion in the width direction of the spine and including a locking member having a hook portion, the locking member being integrally provided with the first main body;
the second main body secured on the inner side of the spine so as to be located on a second side of the central portion in the width direction of the spine and arranged so as to be openable and closable together with the first main body;
a first prong member mounted to the first main body and having a plurality of prongs formed therein; and
a second prong member mounted to the second main body and having a plurality of prongs formed therein.
